(19) United States
(12) Patent Application Publication
(10) Pub. No.: US 2008/0084867 A1
(43) Pub. Date: Apr. 10, 2008

(54) Method and server for transferring a multimedia session from a first terminal to a second terminal

(76) Inventors: George Foti, Dollard des Ormeaux (CA); Sorin Surdila, Laval (CA)

Correspondence Address: ALEX NICOLAESCU;Ericsson Canada Inc., Patent Department, 8400 Decarie Blvd., Town Mount Royal, QC, H4P 2N2, US

(21) Appl. No.: 11/525,960

(22) Filed: Sep. 25, 2006

(51) Int. Cl. H04L 12/66

(52) U.S. Cl. 370/352

(57) ABSTRACT

A method and a server are provided for transferring a multimedia session from a first terminal to a second terminal. The session having been set up, with the help of an application server, between the first terminal and a service network comprising a content server, a user of the first terminal enters a command to pause the session. A session identity is stored in the application server. The user then turns to the second terminal, which obtains the session identity from the application server. The second terminal can then send a request to the content server to resume the session, the session identity being used to specify to the content server which session is to be resumed.

### BACKGROUND OF THE INVENTION

1. Field of the Invention

The present invention relates to a method and a server for transferring a session in a multimedia service network from a first terminal to a second terminal.

2. Description of the Related Art

Internet Protocol (IP) Multimedia Subsystem (IMS) based IP Television (IPTV) is a new service that is currently being introduced within a service layer of an IMS network. An IMS specification ‘3GPP TS 23.228 v7.4.0 (2006-06) “3^{rd} Generation Partnership Project; Technical Specification Group Services and System Aspects; IP Multimedia Subsystem (IMS); Stage 2 (Release 7)”’ provides service descriptions for the IMS core network. The IMS core network in turn includes elements necessary to support IP multimedia services.

Another IMS specification ‘3GPP TS 33.203 v7.2.0 (2006-06) “3^{rd} Generation Partnership Project; Technical Specification Group Services and System Aspects; 3G security; Access security for IP-based services (Release 7)”’ provides authentication mechanisms that are useful in ensuring validity of requests received from terminals for obtaining multimedia services such as IPTV.

FIG. 1 (prior art) provides a high-level view of an IMS network architecture for supporting IPTV and other multimedia applications. A service network 100 is shown comprising a first terminal 110 and a second terminal 120, both capable of being used by end-users to enjoy IPTV and other multimedia contents. Contents are provided to the terminals 110, 120 by a content server 130. The content server 130 acts as an aggregator of information and may comprise video, audio, games, photos, text, etc. These different types of media are generally stored on a hard drive at the content server 130. In the service network 100, contents are sent by the content server 130 by use of Real-Time Streaming Protocol (RTSP) media flows 140. RTSP is defined by the Internet Engineering Task Force (IETF) in ‘Request For Comments (RFC) 2326 “Real Time Streaming Protocol (RTSP)”, April 1998’. Multimedia sessions are set up between the terminals 110, 120 and the content server 130 by use of an application server 150. The application server 150 runs software functions to control setting up of sessions between the terminals 110, 120 and the content server 130. For example, the application server 150 may handle authentication of users, billing of sessions, selection of one amongst several content servers 130 based on performance parameters, and the like. Set up of sessions is made by use of SIP messages exchanged on signalling links 160. The IETF defines SIP messages in ‘RFC 3261 “SIP: Session Initiation Protocol”, June 2002’.

The PCT publication WO 2006/000624, assigned to Telia Sonera Finland Oyj, dated May 1st, 2006, describes a system and method for transferring a session from a first to a second terminal. That reference comprises what is commonly known as a “push model”, meaning that a first terminal having initiated the session is required to support special features for actively initiating (i.e. pushing) the transfer of the session towards the second terminal. In the reference, the user must send a request from the first terminal to initiate transfer of the session towards the second terminal, the request comprising authentication information of the first terminal. Furthermore, user interaction is important because the user must enter his own SIP address, for example on a web site, to activate the transfer.

There would be clear advantages of having a method and a server for allowing transferring a session between terminals in an efficient manner, without requiring complex user interaction.

### SUMMARY OF THE INVENTION

It is therefore a broad object of this invention to provide a method and a server for transferring a session, in a service network, from a first terminal to a second terminal by use of a “pull model”. The second terminal can, according to the present invention, pull the session away from the first terminal with minimal interaction between the first terminal and the service network.

A first aspect of the present invention is directed to a method implemented in a network for transferring a session from a first terminal to a second terminal. Having set up the session between the first terminal and a content server, the first terminal sends a pause message to the content server. The first terminal then sends a session identity of the paused session to an application server. Thereafter, the second terminal sends a message to the application server, requesting to get information related to the session that is currently being paused. The application server replies by sending the session identity to the second terminal. Using the session identity, the second terminal then requests from the content server resumption of the session.

A second aspect of the present invention is directed to a variant of the hereinabove method wherein the application server uses authentication means to verify that the first terminal and second terminal are related, prior to sending the session identity to the second terminal.

A third aspect of the present invention is directed to a variant of the hereinabove methods wherein one of the first and second terminal is a fixed terminal and the other one of the first and second terminal is a mobile terminal.

A fourth aspect of the present invention is directed to a variant of the hereinabove methods wherein a user of the first and second terminals has a plurality of ongoing sessions. The application server sends to the second terminal session identities for each of the plurality of ongoing sessions. The subscriber selects to resume one or more sessions. The second terminal then requests from the content server resumption of the one or more sessions.

A fifth aspect of the present invention is directed to a server for setting up a session with a terminal. The server comprises an input port and an output port for receiving and sending messages, a memory for storing a session identity, and a logic unit for writing the session identity in the memory and for reading the session identity from the memory. The logic unit is configured to order writing of a session identity in the memory so that the terminal can pause the session and later resume the session. The input port can accept receiving from one terminal a message intended for resuming the session when the session has been initiated and then paused by another terminal.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (prior art) provides a high-level view of an IMS network architecture for support of IPTV and of other multimedia applications;

FIG. 2 shows a sequence diagram of a first exemplary method for transferring a session from a first terminal to a second terminal;

FIG. 3 shows a sequence diagram of a second exemplary method for transferring a session from a first terminal to a second terminal;

FIG. 4 shows an exemplary terminal built according to the present invention; and

FIG. 5 shows an exemplary server built according to the present invention.

### DETAILED DESCRIPTION

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the description of the figures, like numerals represent like elements of the invention.

The present invention provides a method and a server for transferring a session, for example a multimedia session, currently being served by a content server, from a first terminal to a second terminal. The session may for example be an Internet Protocol (IP) Television (IPTV) program and the first and second terminals may be standard TV sets, desktop computers, mobile terminals and the like. The session having been set up between the first terminal and the content server by conventional means involving the assistance of an application server, the content server is at the time sending a content towards the first terminal. The application server and the first terminal may both have a copy of a session identity their memories. The session identity may be defined, for example, by the content server when the session is first set up. It may be an alphanumeric character string of any arbitrary length, preferably with a length of 8 bytes or more. In the context of the present invention, the format of the session identity is irrelevant, as long as it has a sufficient length to uniquely identify the session between the terminals, the content server and the application server. RFC 2326 “Real Time Streaming Protocol (RTSP)” defines a RTSP-specific format of the session identity, which is one of the formats that may be used in the present invention. A user of the first terminal enters a command on the first terminal to pause the session. The first terminal signals to the content server that sending the session content shall be paused, or held, at that point in time. The first terminal then sends a correlation message comprising the session identity towards the application server, which may take note of the fact that the session is currently being paused. The first terminal is from that moment no longer involved in transactions leading to transferring of the session towards the second terminal. The user then turns to the second terminal and enters a command indicating a desire to resume the session on that second terminal. The second terminal sends a message towards the application server, requesting to receive the identity of the session currently being paused. The application server sends the session identity towards the second terminal. The second terminal then sends a resume message comprising the session identity to the content server, which resumes sending its content to the second terminal.

In an embodiment comprising only one session for the subscriber, the application server does not need to store the identity of the session when the session is active.

In an alternate embodiment, the subscriber may have more than one session simultaneously active on one terminal. The subscriber may further have ownership of a plurality of terminals and may be using more than one of the terminals simultaneously, possibly having more than one session active over one or more terminals at the same time. For example, the subscriber may have an active IPTV session on a standard TV set while a family member of the subscriber has gaming and music download sessions active on a desktop computer. For a same subscription for the subscriber, the application server may thus hold a context comprising one or more session identities, along with a current status indicating whether each session is currently active or inactive. The method and the server of the present invention may operate to transfer any of the one or more sessions from any first terminal to any other second terminal.

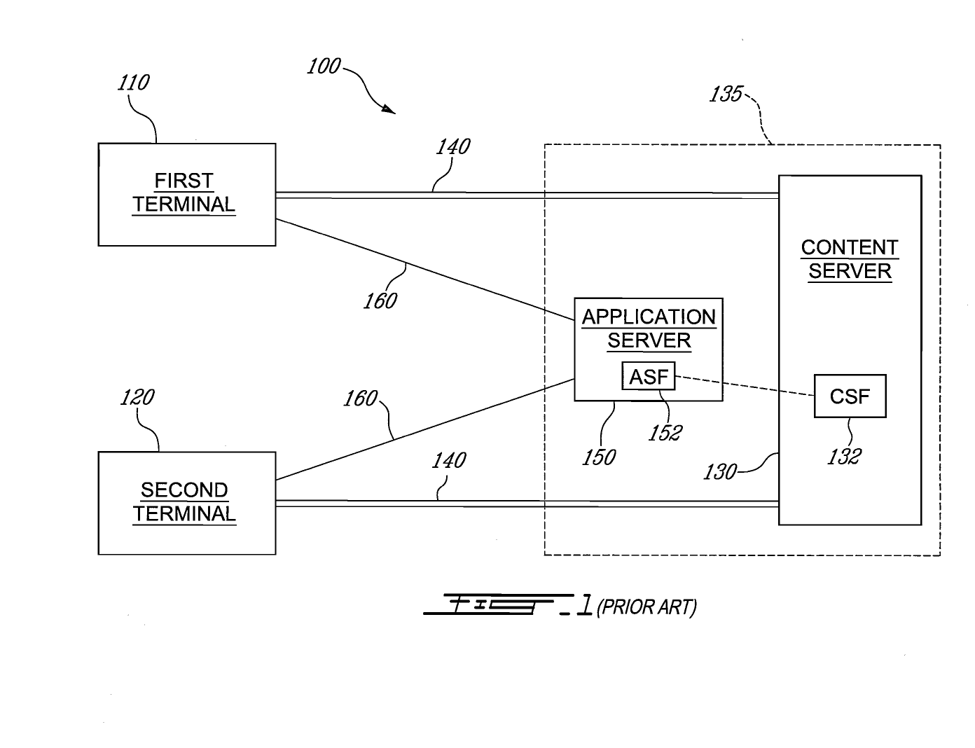

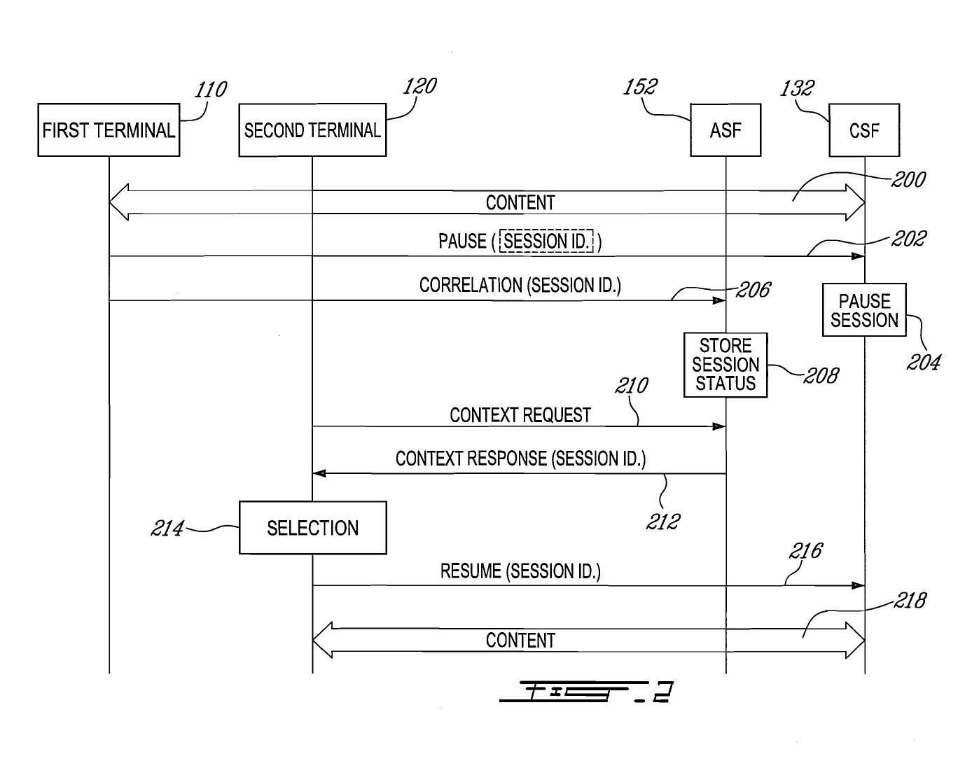

Reference is now made again to FIG. 1 (prior art), which provides a high-level view of an IMS network architecture for support of IPTV and of other multimedia applications. The IMS network architecture shown in FIG. 1 is an example of a service network that may benefit from the advantages of the present invention.

FIG. 1 shows the content server 130, comprising a Content Serving Function (CSF) 132, and the application server 150, comprising an Application Serving Function (ASF) 152. The ASF 152 controls setting up of sessions between terminals 110, 120 and the CSF 132, and preferably stores information about ongoing sessions for a user of the terminals 110, 120. The CSF 132 may provide information to the ASF 152 about its capabilities and current load. The ASF 152 may use this load information from the CSF 132 to determine whether or not the CSF 132 may support more sessions. The ASF 152 may also select the CSF 132 according to capabilities of the CSF 132 and capabilities of the terminals 110, 120. For example, the ASF 152 may select the CSF 132 according to a display size of a standard TV set, or according to a display size of a handheld portable terminal, depending on a content format within the CSF 132. However, there is no mandatory relationship between the CSF 132 and the ASF 152.

FIG. 1 shows the content server 130 and the application server 150 as two distinct servers. Alternatively, the ASF 152 and the CSF 132 may be comprised in a single combined server 135. However, the CSF 132 is advantageously located in close proximity of the user in order to facilitate transport of large multimedia contents between the CSF 132 and the terminals 110, 120. There is no such advantage related to the location of the ASF 152 because the ASF 152 only sends and receives signalling in small amounts. Because location requirements of the ASF 152 and of the CSF 132 differ, the two function types are preferably implemented in distinct nodes. Also, in a case where a CSF 132 is co-located with a ASF 152 in a combined server 135, a user may be in contact with the ASF 152 of the combined server 135, and at the same time receive multimedia content from a distinct content server 130.

The service network of FIG. 1 may also comprise Call Session Control Function (CSCF) nodes (not shown), for example a Proxy-CSCF (P-CSCF) and a Serving-CSCF (S-CSCF). These nodes are known in the prior art and provide means for the first and second terminals to log in the IMS network. Paths 160 are shown between the first and second terminals towards the application server, the paths 160 possibly comprising the P-CSCF, the S-CSCF, routers, and the like.

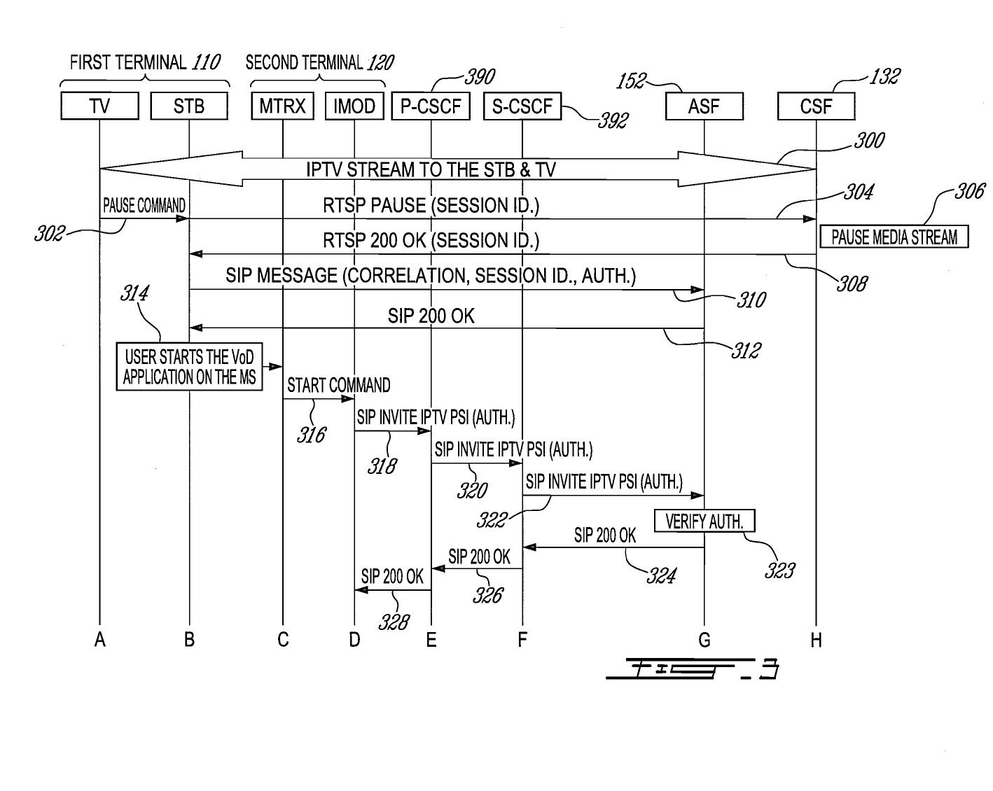

Having now described hereinabove the IMS network architecture of FIG. 1, an aspect of the preferred embodiment of the present invention will now be described by reference to FIG. 2 which shows a sequence diagram of a first exemplary method for transferring a session from a first terminal 110 to a second terminal 120. In this exemplary sequence diagram, a session has been set up by a service network 100 between the first terminal 110 and the CSF 132 comprised in the content server 130. At the time of setting up the session, a session identity has been stored in the first terminal 110.

A content is being transferred from the CSF 132 to the first terminal 110 at step 200. At step 202, responsive to a user input, the first terminal 110 sends a pause message towards the CSF 132. The pause message may preferably comprise the session identity. The session identity is not required in the pause message if there is only one active session for the first terminal 110. The CSF 132 pauses transmission of the media stream at step 204, using the session identity to specifically pause one session where more than one session is currently active for the same user. The first terminal then sends at step 206 a correlation message comprising the session identity for the session currently being paused, towards the ASF 152. At step 208, the ASF 152 stores the session identity, if not already known to the ASF 152, and takes note that the session is currently being paused by storing a session status set to inactive. Where more than one session is currently active for the same user, the session identity received in the correlation message is used by the ASF 152 to specifically point to the session that is being paused.

Thereafter, responsive to an input from the user, the second terminal 120 sends a context request message towards the ASF 152 at step 210. The ASF 152 replies at step 212 by sending a context response message comprising one or more session identities towards the second terminal 120. At step 210, the ASF 152 may have session identities corresponding to one or more sessions for the user of the first and second terminals 120, each session having been paused in a manner similar to that shown at steps 202-208. In that case, the context response message sent at step 212 may comprise session identities for all sessions related to the user. At step 214, the user may optionally select to resume the paused session. This step may comprise selection by the user of one or more sessions to be resumed, based on session information received in the context response message. If however there is only one session, in some embodiments, step 214 may be automated in the second terminal 120 and not require any user interaction. At step 216, the second terminal sends a resume message towards the CSF 132. The resume message comprises session identities for one or more sessions selected by the user or automatically selected by the second terminal 120. At step 218, the CSF 132 resumes sending the content towards the second terminal 120.

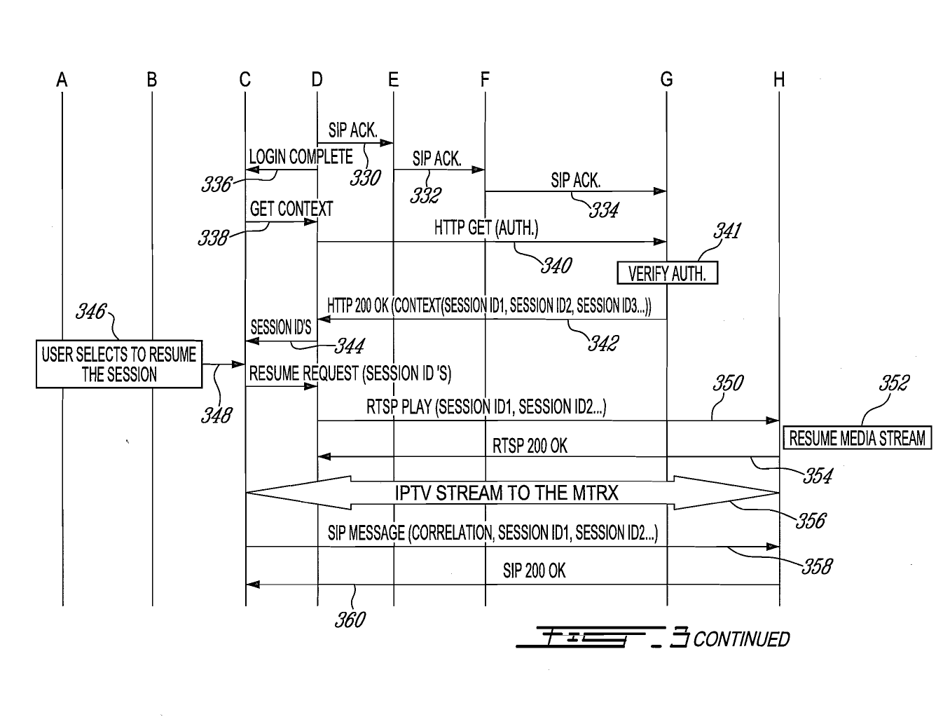

Another aspect of the preferred embodiment of the present invention will now be described by reference to FIG. 3 which shows a sequence diagram of a second exemplary method for transferring a session from a first terminal 110 to a second terminal 120. In this exemplary sequence diagram, an Internet Protocol Television (IPTV) session has been set up by the service network 100 between the CSF 132 and the first terminal 110. At the time of setting up the session, a session identity has been stored in the first terminal 110. The first terminal 110 may comprise a multimedia device, the multimedia device being for example a standard television receiver or TV set. Of course, the first terminal 110 could comprise many other implementations such as a mobile terminal, a personal computer, a personal digital assistant, and the like. The TV set is connected to a Set Top Box (STB) which is capable of IP communication. The STB may comprise an authentication module further comprising authentication data compliant with IMS specifications. The STB may communicate with the ASF 152 comprised in the application server 150 and with other nodes in the IMS network using signalling defined in IMS specifications. In some embodiments, the TV set and features of the STB could be combined in a single unit. Where the first terminal 110 is a personal computer or a personal digital assistant, features and capabilities of the STB may be internal to the first terminal 110.

A media content, which in this case may be a movie or any audio/video content, is being transferred in streaming form from the CSF 132 to the STB at step 300. Depending on the capabilities of the TV set, the STB may forward the content as is to the TV set, or may convert it to, for example, a National Television Systems Committee (NTSC) format, a Phase Alternating Line (PAL) format, or a High Definition TV (HDTV) format. At step 302, responsive to a user input, the TV set sends a pause command to the STB. If the TV set is not capable of sending this command, the user may alternatively enter the pause command directly by use of a user interface of the STB. In some embodiments, the STB may detect at step 302 that the TV set has been turned off by the user. The STB sends a pause message towards the CSF 132 at step 304, the pause message preferably being a Real-Time Streaming Protocol (RTSP) Pause message. The pause message may preferably comprise the session identity. The CSF 132 pauses transmission of the media stream at step 306, using the session identity to specifically pause one session where more than one session is currently active for the same user. If however there is only one session currently active for the user, it may not be necessary to have the session identity included in the pause message. The CSF 132 then responds to the STB at step 308, sending an acknowledgement message, which may preferably be a RTSP 200 OK message, the acknowledgement message preferably comprising the session identity. Upon receipt of the acknowledgement, the STB sends at step 310 a correlation message, for example a SIP message comprising an indication that the message is about session correlation, and the session identity for the session currently being paused, towards the ASF 152. The correlation message may further comprise authentication data of the first terminal 110, the authentication data belonging to the STB. The ASF 152 takes note that the session is currently being paused, stores the session identity, and sends an acknowledgement, for example a SIP 200 OK message, towards the STB.

Thereafter, possibly after any reasonable delay that may be acceptable to the CSF 132 and to the ASF 152 according to their internal parameters, the user enters at step 314 an input on the second terminal 120 to resume the session currently being paused. The exemplary second terminal 120 shown at FIG. 3 is a mobile terminal, comprising both a Mobile Transceiver (MTRX) part and an Identification Module (IMOD) part. The MTRX part generally is a standard mobile terminal with advanced audio and display capabilities. The IMOD part comprises a terminal identity, and authentication data complying with IMS specifications regarding access security. Of course, the second terminal 120 could comprise many other implementations such as another TV set with its own STB, a laptop computer, a personal digital assistant, and the like. The MTRX sends at step 316 a start command towards the IMOD. The start command, and any message exchanged between the MTRX and the IMOD, may be an internal signal if the MTRX and the IMOD are integrated in a single device; the start command of step 316 may actually not be present in some implementations of the second terminal 120 where the MTRX and the IMOD are fully integrated. The IMOD then initiates a login process towards the ASF 152. In a preferred embodiment, the ASF 152 is reachable through a Session Initiation Protocol (SIP) domain and the login is performed by exchanging messages according to SIP specifications. The login process extends through steps 318-334 as described hereinbelow. The IMOD sends at step 318 a message towards a P-CSCF 390, the message being intended to initiate the login process. The message sent by the IMOD may comprise authentication data of the IMOD. The message sent at step 318 is preferably a SIP Invite IPTV Public Service Identity (PSI) message. The P-CSCF 390 forwards at step 320 the SIP Invite IPTV PSI message towards a S-CSCF 392 which, in turn, forwards the message towards the ASF 152 at step 322. The ASF 152 may verify at step 323, by use of the authentication data received in both of the SIP Invite IPTV PSI message and the correlation message, that the second terminal 120 is related to the first terminal 110. Authentication data received from the two terminals point to a same subscription for the user in a normal case wherein no malicious terminal is attempting to use the session. The ASF 152 accepts the login and replies with a SIP 200 OK message sent towards the S-CSCF 392 at step 324. The S-CSCF 392 forwards the SIP 200 OK message towards the P-CSCF 390 at step 326 and, in turn, the P-CSCF 390 forwards the message towards the IMOD at step 328. The IMOD replies with a SIP Acknowledgement sent towards the P-CSCF 390 at step 330 and this message is forwarded towards the S-CSCF 392 at step 332 and towards the ASF 152 at step 334. At step 336, the IMOD informs the MTRX that the login process is completed. Like the start command of step 316, the login complete signal may be an internal signal if the MTRX and the IMOD are integrated in a single device; the login complete signal may actually not be present in some fully integrated implementations of the second terminal 120.

At step 338, the MTRX requests that the IMOD initiates getting a context for the user. The context may comprise one or more session identities for one or more sessions currently being served to the user. At step 340, the IMOD sends a context request message, preferably a Hyper Text Transfer Protocol (HTTP) GET message, towards the ASF 152. The context request message may comprise authentication data coming from the IMOD. The ASF 152 may again verify at step 341, by use of the authentication data received in the context request message and in the correlation message, that the second terminal 120 is related to the first terminal 110. The ASF 152 replies at step 342 by sending a context response message, preferably in the form of a HTTP 200 OK message comprising the context, itself comprising one or more session identities, towards the second terminal 120, more particularly towards the IMOD. The context response message may further comprise an address of the CSF 132. At step 344, the IMOD forwards the session identities for the one or more sessions to the MTRX. At step 346, the user may select to resume the paused IPTV session. This step may alternatively comprise selection by the user of one or more sessions to be resumed. While only a single IPTV session would expectedly be selected by the user at step 346, in other exemplary uses of the present invention, a plurality of sessions could be resumed concurrently such as, for example, a gaming session along with a music streaming session. If however there is only one session, in some embodiments, step 346 may be automated in the MTRX and not require any user interaction. At step 348, the MTRX forwards a resume request to the IMOD, the resume request comprising an indication of which session or sessions is or are to be resumed. The IMOD sends a resume message, preferably a RTSP Play message, towards the CSF 132 at step 350. The resume message comprises session identities for one or more sessions selected by the user. At step 352, the CSF 132 resumes sending the audio/video content, or other multimedia content, in streaming form. The CSF 132 sends a RTSP 200 OK towards the IMOD at step 354, and the audio/video content is sent continuously from the CSF 132 towards the second terminal 120 at step 356. The IMOD sends towards the ASF 152, at step 358, another correlation message, also in the form of a SIP message, comprising an indication that the message is about session correlation and comprising the session identity for each session being resumed. The ASF 152 updates the session status by marking each resumed session active, and responds towards the IMOD by sending a SIP 200 OK at step 360.

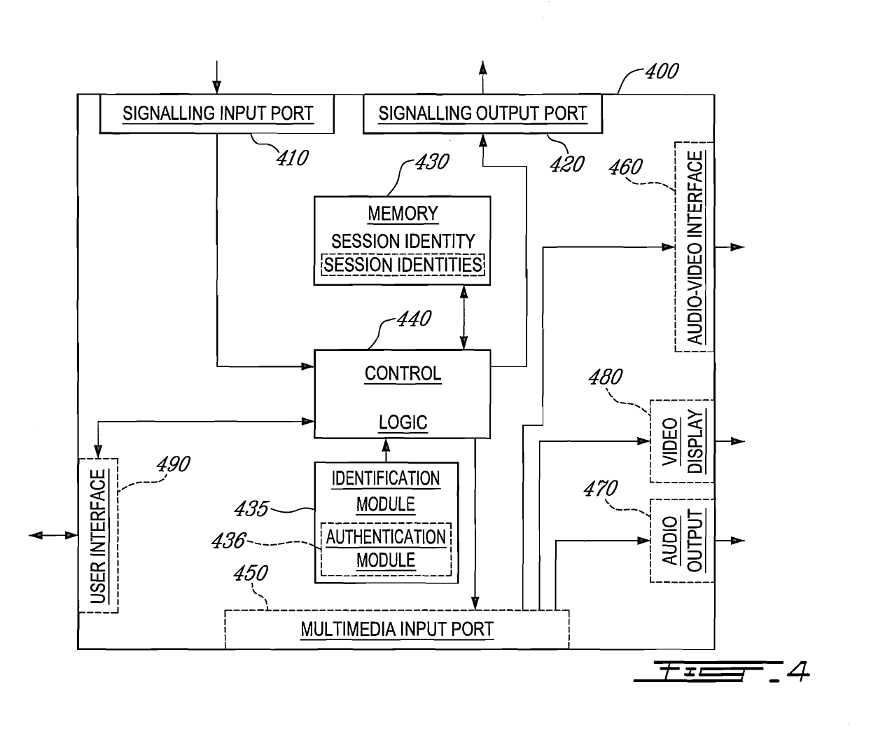

An exemplary construction of a terminal 400 capable of being used as the terminals of the preceding figures, will now be described by reference to FIG. 4, which shows an exemplary terminal built according to the present invention. The terminal 400 may comprise at least in part capabilities of either or both of the first terminal 110 and the second terminal 120. The terminal 400 may be a fixed terminal such as, for example a STB or a desktop computer. The terminal 400 may alternatively be a mobile terminal such as a cellular phone, or a laptop with Wireless Local Area Network (WLAN) connection capabilities. In the embodiment of FIG. 4, the terminal 400 comprises a signalling input port 410, a signalling output port 420, a memory 430, an identification module 435, and a control logic 440. The terminal 400 may comprise an audio-video interface 460, an audio output 470 and a video display 480, a multimedia input port 450, an authentication module 436, and a user interface 490.

The signalling input port 410 is capable of receiving signals coming from the application server 150, from the content server 130, from IMS nodes such as from the P-CSCF and, optionally, from an external multimedia terminal such as an intelligent TV set. The signalling output port 420 is configured for sending signals towards the content server 130, the application server 150 and to other nodes such as for example the P-CSCF 290 and, optionally, to an external multimedia terminal. The signalling input port 410 and the signalling output port 420 may support wired connections, such as Ethernet, cable or Digital Subscriber Line (DSL) connections, or wireless connections such as cellular or WLAN connections.

The memory 430 stores one or more session identities for ongoing multimedia sessions for a user of the terminal 400. The identification module 435 stores an identity for the terminal 400. The identification module 435 may also comprise the authentication module 436 for storing authentication data for the terminal 400.

The user interface 490 may receive commands from the user of the terminal 400 for setting up, pausing, resuming and clearing sessions with the content server 130. The user interface 490 may also provide the user with information regarding ongoing sessions. If the terminal 400 is capable of supporting gaming sessions, the user interface 490 may be used to play games. The user interface 490 may not be present in cases where the signalling input port 410 is capable of receiving set up, pause, resume and clear commands from an external multimedia terminal and where the signalling output port 420 is capable of presenting session information towards the user. Alternatively, the audio-video interface 460 or the video display 480 may be used for presenting session information to the user.

When a session is active, the multimedia input port 450 is capable of receiving content from the content server 130, for example in the form of a streaming RTSP media flow. The multimedia input port 450 may not be present if the signalling input port 410 has the same capabilities. The terminal 400 may comprise an audio-video interface 460 for connecting an external device, such as an ordinary TV set, a computer screen, or any other display type. Alternatively or in addition, the terminal 400 may comprise its own video display 480 and its own audio output 470. The audio output 470 may take the form of one or more speakers or a speaker connection such as for example an ordinary audio jack. Content received at the multimedia input port 450 or at the signalling input port 410 is displayed either at the audio-video interface 460 or at the video display 480 and at the audio output 470.

The control logic 440 processes user commands received from the user interface 490 or from the signalling input port 410. If the control logic 440 receives a pause command, it orders the signalling output port 420 to send a pause message towards the content server 130. The control logic 440 may request the signalling output port 420 to include in the pause message a session identity that it reads from the memory 430. If the control logic 440 receives a start command, it orders the signalling output port 420 to send a SIP Invite PSI message towards the P-CSCF 290, optionally including in the message authentication data of the terminal 400 read from the authentication module 436. When the signalling input port 410 receives from the P-CSCF 290 a response to the SIP Invite PSI message, for example a SIP 200 OK message, it informs the control logic 440, which requests the signalling output port 420 to send a context request message, for example a HTTP GET message, towards the application server 150, optionally including in the message authentication data of the terminal 400 read from the authentication module 436. When a context response message, for example a HTTP 200 OK message, comprising a context of the session arrives at the signalling input port 410, if the context comprises a session identity for a single session, the control logic 440 may autonomously proceed with resumption of the session. Alternatively, especially where the context comprises session identities for more than one session, the control logic 440 forwards information regarding the session or sessions towards the user by use of the user interface 490 or by use of the signalling output port 420. When the control logic 440 receives a user selection through the user interface 490 or through the signalling input port 410, or when the control logic 440 autonomously decides to proceed with resuming the session, the control logic 440 requests the signalling output port 420 to send a resume message, for example a RTSP Play message, towards the content server 130. Thereafter, the control logic informs the multimedia input port 450 or the signalling input port 410 that content, such as audio-video content, may be received and displayed at the audio-video interface 460 or on the video display 480 and on the audio output 470.

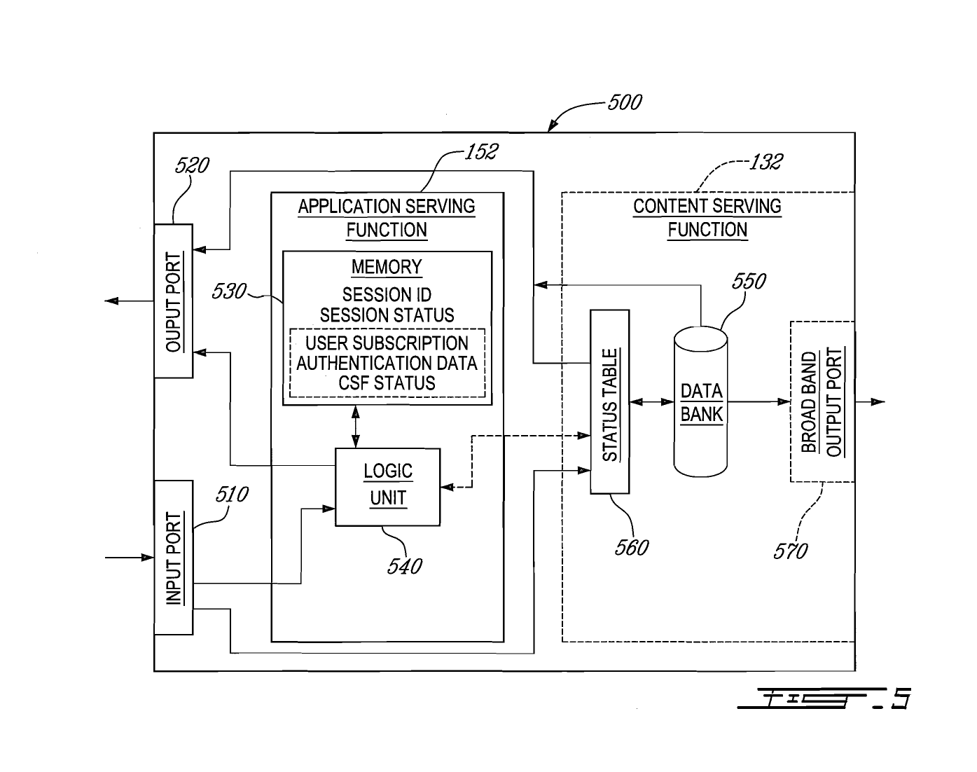

An exemplary construction of a server 500 capable of being used as any of the servers of the preceding figures, will now be described by reference to FIG. 5, which shows an exemplary server 500 built according to the present invention. The server 500 may comprise the features and capabilities of the application server 150. It may also comprise the capabilities of the content server 130, thereby comprising all features of the combined server 135.

The server 500 comprises an input port 510 and an output port 520 for exchanging messages with terminals and with other nodes such as, for example, the S-CSCF 292 or a separate content server 130. The server 500 also comprises an Application Serving Function (ASF) 152. The ASF 152 comprises a memory 530 and a logic unit 540. The server 500 may optionally comprise a Content Serving Function (CSF) 132, the CSF 132 comprising a data bank 550 and a status table 560, which may indicate that a session is active, inactive, or paused. The CSF 132 also preferably comprises a broadband output port 570.

When a user initiates a request to set up a session such as a multimedia session, his terminal sends a request that arrives at the server 500 through the input port 510. The logic unit 540 analyses the request. Analysis of the request may optionally comprise verification of a user subscription in the memory 530. The analysis may additionally include verification of a status of a content server 130 by sending a message through the output port 520 towards the content server 130, verification of a status of the CSF 132 by use of optional internal signalling between the logic unit 540 and the status table 560, or verification of a pre-stored status in the memory 530 for the content server 130 or for the CSF 132. If the request is accepted by the logic unit 540, the logic unit 540 may store a session identity, along with a session status indicating that the session is active, in the memory 530. The logic unit 540 then requests the output port 520 to send towards the terminal information about which node will provide a content of the session. The content of the session may be provided by the CSF 132 comprised in the server 500, or by a distinct content server 130. The request received from the terminal at the input port 510 may take the form of a HTTP GET message. The request may be preceded by a login in the form of a SIP Invite IPTV PSI message received at the input port 510 from the S-CSCF 292 as a result of a command from the terminal, in which case the login is acknowledged by the server 500 by use of sending a SIP 200 OK message sent through the output port 520 towards the S-CSCF 292.

When the user enters a command at the terminal to pause the session, the terminal sends a correlation message towards the server 500. The correlation message arrives at the input port 510. The correlation message intended to the ASF 152 may comprise the session identity and authentication data for the user of the terminal. In the ASF 152, the logic unit 540 writes the session identity and the authentication data, if received in the correlation message, in the memory 530. The ASF 152 may preferably set the session status to inactive in the memory 530. When the user enters another command to resume the session, the resume command being possibly initiated from the same terminal or from another terminal, that terminal sends a context request message, for example another HTTP GET message, towards the server 500. The message arrives at the input port 510 and is analysed by the logic unit 540. If the context request message comprises authentication data, the logic unit 540 may verify, by use of authentication information earlier stored in the memory 530, that the context request message corresponds to the same user as that of the correlation message. Provided that the context request message is authenticated, the logic unit 540 orders sending through the output port 520, towards the terminal having sent the context request message, a context response message comprising the session identity read from the memory 530. The context request message may be preceded by a login in the form of a SIP Invite IPTV PSI message received from the S-CSCF 292 on behalf of the terminal used by the user to resume the session. The SIP Invite IPTV PSI message received at the server 500 through the input port 510 may also comprise authentication data which, if included, is verified by the logic unit 540 by use of earlier data stored in the memory 530.

If the server 500 comprises the optional CSF 132, when the user initiates a request to set up the session as described hereinabove, his terminal sends a start message (not shown), for example a RTSP Start message, that arrives to the server 500 through the input port 510. The message is forwarded to the status table 560. The status table 560 takes note that the session has been set up and changes the session status from inactive to active. The status table 560 then orders the data bank 550 to start sending content, for example streaming video, towards the terminal. The content may be output from the server 500, for example in the form of a RTSP media flow, through the output port 520 or through a broadband output port 570. When the user enters the command at the terminal to pause the session, the terminal sends a pause message, for example a RTSP Pause message, comprising a session identity. The pause message arrives at the input port 510. The message is forwarded to the status table 560, which marks the session as paused, and orders the data bank 550 to stop sending content. The status table 560 orders sending of an acknowledgement message towards the terminal, through the output port 520, the acknowledgement message preferably comprising the session identity. Thereafter, the input port 510 receives a resume message, for example a RTSP Play message from the same terminal or from another terminal. The resume message preferably comprises a session identity. The input port 510 forwards the message towards the status table 560. The status table 560 marks the session active and orders the data bank 550 to resume sending its content towards the terminal which now has the session. The input port 510 then receives from the terminal currently having the session another correlation message intended to the ASF 152. The logic unit 540 sets the session status to active in the memory 530 and orders the output port 520 to send an acknowledgement towards the terminal.

Although several aspects of the preferred embodiment of the method and of the server of the present invention have been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

1. In a network comprising a content serving function and an application serving function for setting up sessions between terminals and the content serving function, a method of transferring a session from a first terminal to a second terminal, the method comprising the steps of:
sending from the first terminal towards the content serving function a pause message;
sending from the first terminal towards the application serving function, a correlation message comprising a session identity;
sending from the second terminal towards the application serving function a context request message;
sending from the application serving function towards the second terminal a context response message comprising the session identity; and
sending from the second terminal towards the content serving function a resume message comprising the session identity.

2. The method of claim 1, wherein:
the first terminal and the second terminal comprise authentication data;
authentication data of the first terminal is sent in the correlation message;
authentication data of the second terminal is sent in the context request message; and
the application serving function uses the authentication data of the first and second terminals to verify that the first and second terminals are related before sending the context response message.

3. The method of claim 1, wherein:
the session is a multimedia session.

4. The method of claim 3, wherein:
the multimedia session is a video session.

5. The method of claim 1, wherein:
one of the first and second terminals is a fixed terminal comprising a multimedia device, and an authentication module complying with Internet Protocol (IP) Multimedia Subsystem (IMS) specifications.

6. The method of claim 5, wherein:
the multimedia device is a television set; and
the authentication module is in a set-top box.

7. The method of claim 1, wherein:
one of the first and second terminals is a mobile terminal comprising an identification module.

8. The method of claim 7, wherein:
the identification module comprises authentication data complying with IMS specifications.

9. The method of claim 1, wherein:
the content serving function sends a pause acknowledgement message towards the first terminal, responsive to receiving the pause message; and
the first terminal sends the correlation message responsive to receiving the pause acknowledgement message.

10. The method of claim 1, wherein:
before sending the context request message, the second terminal logs in a SIP domain.

11. The method of claim 10, wherein logging in the SIP domain further comprises the steps of:
sending a SIP invite message from the second terminal towards a proxy Call Session Control Function (CSCF);
forwarding the SIP invite message from the proxy CSCF towards a serving CSCF;
forwarding the SIP invite message from the serving CSCF towards the application serving function; and
sending a SIP 200 OK message from the application serving function through the serving CSCF and through the proxy CSCF towards the second terminal.

12. The method of claim 11, wherein:
the first terminal and the second terminal comprise authentication data;
authentication data of the first terminal is sent in the correlation message;
authentication data of the second terminal is sent in the SIP invite message; and
the application serving function uses the authentication data of the first and second terminals to verify that the first and second terminals are related before sending the SIP 200 OK message.

13. The method of claim 1, wherein:
the pause message and the resume message are Real-Time Streaming Protocol (RTSP) messages;
the context request message is a Hyper Text Transfer Protocol (HTTP) GET message; and
the context response message is a HTTP 200 OK message.

14. The method of claim 1, wherein:
the content serving function sends a content in streaming form towards the first terminal before receiving the pause message; and
the content serving function sends the content in streaming form towards the second terminal after receiving the resume message.

15. The method of claim 1, wherein:
a content server comprises the content serving function and the application serving function.

16. The method of claim 1, wherein:
a content server comprises the content serving function; and
an application server comprises the application serving function.

17. The method of claim 1, wherein:
the context response message comprises session identities of a plurality of sessions; and
responsive to a user selection amongst the plurality of sessions, the second terminal sends the resume message comprising one or more session identities of one or more selected sessions.

18. A server, comprising:
an input port for receiving from a terminal a correlation message comprising a session identity and for receiving from the same terminal or from another terminal a context request message;
a memory for storing the session identity;
an output port for sending towards the terminal having sent the context request message a context response message comprising the session identity read from the memory; and
a logic unit for writing in the memory the session identity received in the correlation message and reading from the memory the session identity.

19. The server of claim 18, wherein:
the memory is further for storing user authentication data for a user of the terminal having sent the correlation message; and
the logic unit is further for verifying, by use of the authentication data stored in the memory, that the terminal having sent the context request message is for the same user.

20. The server of claim 18, further comprising:
a content serving function for providing a session content towards a user.

21. The server of claim 20, wherein the content serving function further comprises:
a data bank for storing the session content; and
a status table for storing a status of the session, wherein the status is selected from a group consisting of active, inactive or paused.

22. The server of claim 20, wherein the content serving function further comprises:
a broadband output port for sending the session content towards the user.

23. The server of claim 18, wherein:
the memory is further for storing user authentication data for a user of the terminal having sent the correlation message;
the input port is further for receiving a Session Initiation Protocol (SIP) Invite Public Service Identity (PSI) message from a serving Call Serving Control Function (CSCF);
the logic unit is further for verifying, by use of the authentication data stored in the memory, that the SIP Invite PSI message is for the same user; and
the output port is further for sending a SIP 200 OK message towards the serving CSCF.
